(19) United States
(12) Patent Application Publication
(10) Pub. No.: US 2019/0219893 A1
(43) Pub. Date: Jul. 18, 2019

(54) Magnetically Coupling Filter Tray

(71) Applicants: Jeff Overall, Fountain Valley, CA (US); John Patrick Kiernan-Lewis, Costa Mesa, CA (US)

(72) Inventors: Jeff Overall, Fountain Valley, CA (US); John Patrick Kiernan-Lewis, Costa Mesa, CA (US)

(21) Appl. No.: 15/840,063

(22) Filed: Dec. 13, 2017

(51) Int. Cl. G03B 11/04; G03B 17/56

(52) U.S. Cl. CPC G03B 11/045; G03B 17/56

(57) ABSTRACT

Devices and methods of quickly coupling a camera filter with a camera lens hood or matte box. Magnetism is used to permit easy insertion and removal, while enabling secure coupling of a camera filter tray. The magnets can be embedded in other components of the matte box achieving space efficiency in coupling. Installation and removal process is simplified by elimination of any additional manipulation or component to couple.

### FIELD OF INVENTION

The present invention relates to lens hoods and matte boxes for cameras. Specifically, it relates to coupling of camera filters with a matte box.

### LIST OF PRIOR ART

| | | U.S. Patents | |
|---|---|---|---|
| Patent Number: | Kind Code: | Grant Date: | Patentee: |
| 5,526,194 | A | 1996 Jun. 11 | Ruffell |
| 5,528,328 | A | 1996 Jun. 18 | O'Farrill |
| 7,031,081 | B2 | 2006 Apr. 18 | Petroff |
| 8,903,236 | B2 | 2014 Dec. 2 | Subratie |

### BACKGROUND/PRIOR ART

A matte box is an optical apparatus used to improve the quality of video footage and photography. Matte boxes perform the dual function of blocking unwanted peripheral light and mounting camera filters. Matte boxes are most commonly used in cinematography and high-end photography. Image quality of shots taken while the camera is stationary or in motion can be improved through use of a matte box. Camera filters are inserted into the matte box when it is attached to the camera. A variety of filters with different image altering capabilities are available to produce different effects and improve image quality in different lighting conditions. Ideally, a photographer or videographer can quickly insert and remove different filters to achieve the desired image effect.

Camera filters must be precisely positioned in front of the camera lens to improve image quality. A filter tray, which frames image altering aspect of the camera filter, is inserted into a slot aligned with the optical path of the lens. The tray is supported on three sides by the slot. Traditional matte box designs do not couple the top portion of the tray. This can cause movement or even dislodgment of the filter tray when rotating the camera. Image-damaging movement may also occur if there is any bouncing or turbulence when shooting. Rotation during operation can cause movement of the filter, impairing image quality. The filter may dislodge, resulting in damage or loss.

Camera filters for high-end photography and cinematography are fragile and expensive. Filters can be lost if dislodged while the matte box is attached to a remote unmanned vehicle. In the traditional non-coupled state, the filter may fall and be damaged if the matte box is rotated while other components are manipulated.

The present invention quickly couples the filter tray to the matte box body. Magnetism is used to secure the filter in the matte box. The tray is stabilized and not subject to movement caused by pan or tilt. The matte box can now be used when rotation of the camera is required. Cameras can be oriented in different positions or attached to remote controlled unmanned vehicles with decreased risk of loss or damage of the filter. Magnets are unobtrusively embedded in the filter tray and inner lining of the filter slot, providing means of coupling. This permits the filter tray to be securely coupled, while not requiring any additional coupling components on the outside of the matte box. Magnets are embedded in or attached to existing structures of the matte box, saving space and requiring no additional protrusions to couple. Magnetism allows easy and gentle insertion; the photographer slides the tray into the slot and magnetic force pulls the tray until it abuts the filter slot. This prevents possible damage that can result from pressing the tray. The magnets have sufficient strength to secure the tray and prevent it from dislodging when contacted or rotated. The damage or loss of filters do to ejection is prevented.

### SUMMARY

An exemplary embodiment is discussed. Magnetism is used to quickly couple a camera filter with a matte box. The invention relates to the filter tray and filter slot. Filter tray denotes any apparatus directly coupling the glass or image altering component of a camera filter. Filter slot denotes the aspect of a matte box into which the filter tray is inserted or attached for alignment with the optical path of the camera lens.

In the exemplary embodiment the filter tray is a flat plate, roughly rectangular; there are two flat opposing planar surfaces and four thin, adjacent intervening sides. A circular optical opening in the center is capable of operatively coupling camera filters. Different filters can be inserted and removed from the filter tray. Two magnets are embedded in the bottom side of the filter tray.

The filter slot is configured to receive and contour to the filter tray. The tray is inserted through the top, which remains open. The filter slot has an opening corresponding to the optical opening in the filter tray. Two magnets are embedded in the bottom surface of the filter slot. The magnets align with the filter tray magnets when the filter tray is inserted. Filter slot magnets have complementary polarity to the filter tray magnets.

In the exemplary embodiment the filter tray slides into the filter slot. The magnetic force created when the components are within range pulls the filter tray until the bottom side abuts the bottom surface of the filter slot. The magnetic force created is sufficient to secure the tray in place when the matte box is rotated, vibrated, or forcibly contacted.

Alternative embodiments may utilize a single magnet or additional magnets. The magnets may be embedded within the matte box components or protrude from the surface. Magnet configurations providing sufficient magnetic force are viable.

The matte box may also include multiple filter slots and filter trays to enable stacking of camera filters.

### LIST OF DRAWING NUMERALS

10 Filter Tray

12 Rotatable Frame

14 Optical Opening

15 Image Altering Element

16 Tray Magnets

20 Filter Slot

22 Slot Top

24 Lens-Clamp Screw

25 Modular Accessory Port

26 Lens Clamp

28 Base Magnets

30 Hood

32 Hood Snap-On Tabs

50 Camera Lens

60 Drone Camera

62 Drone

### BRIEF DESCRIPTION OF DRAWINGS

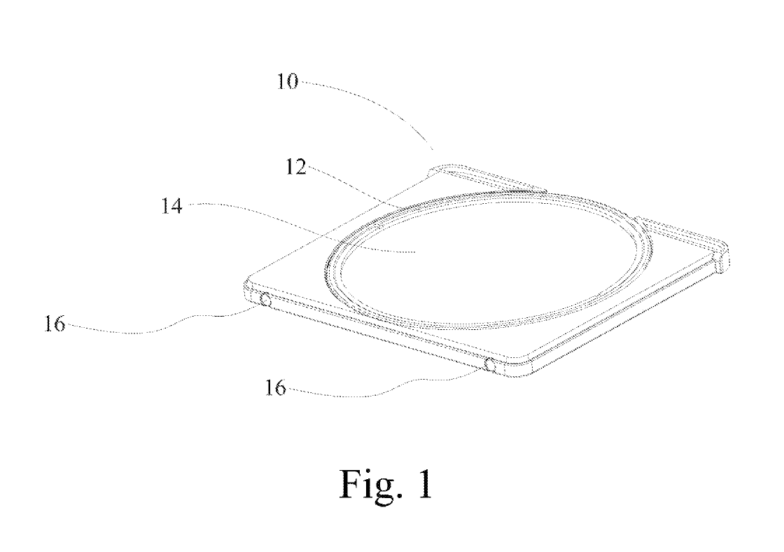

FIG. 1 shows a perspective view of the filter tray

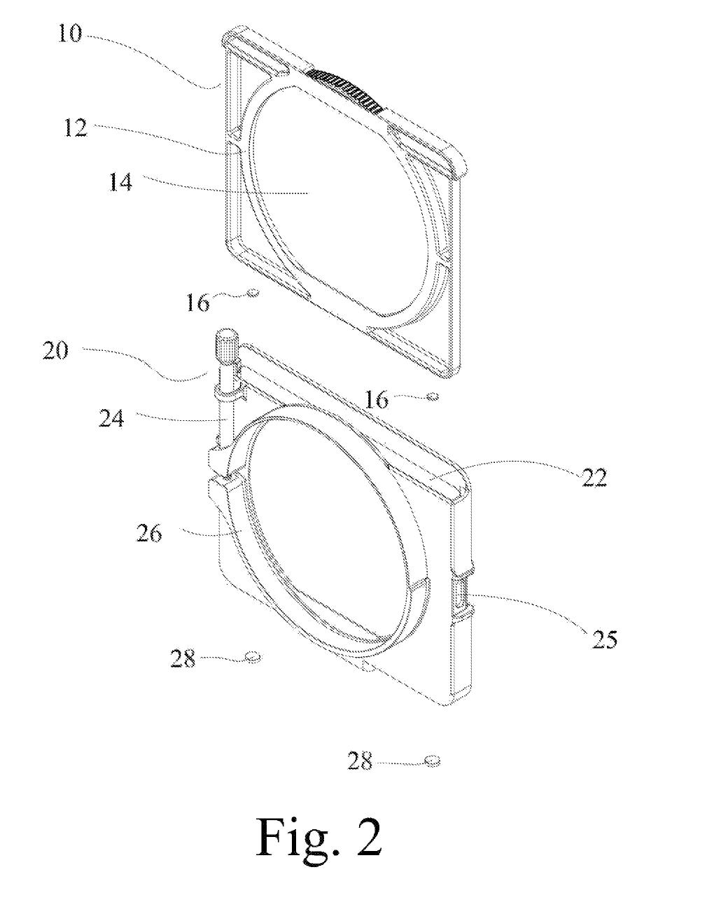

FIG. 2 shows a perspective view of the filter tray and filter slot with exploded magnets.

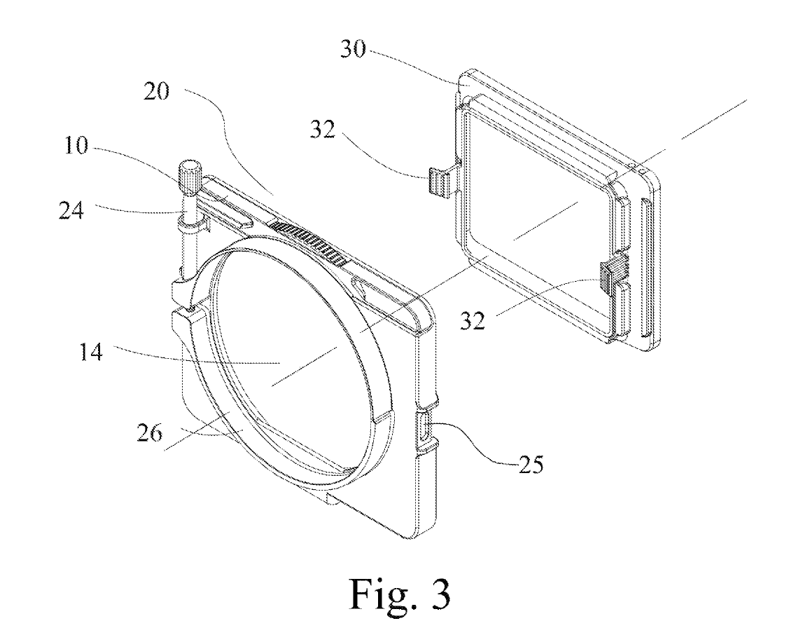

FIG. 3 shows a perspective view of the hood detached from the filter slot.

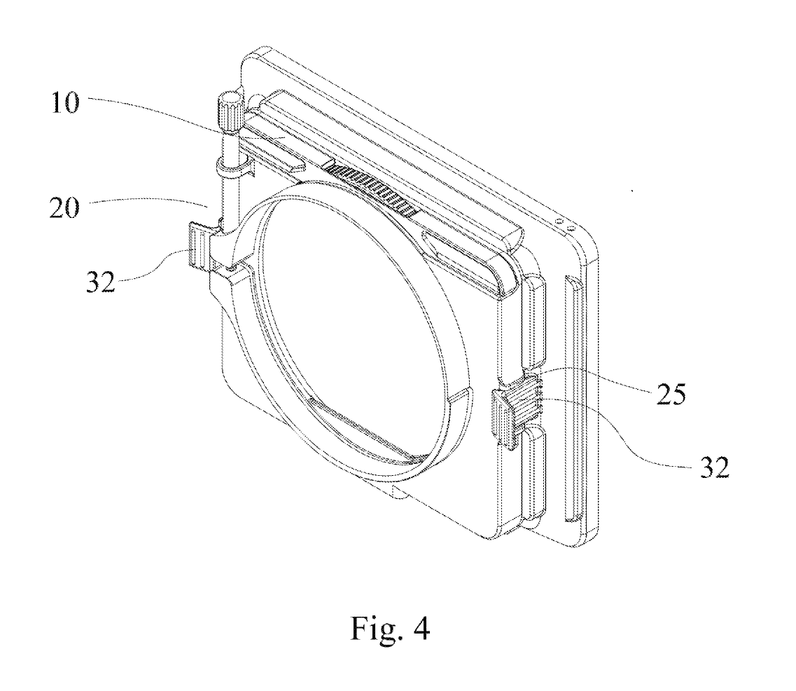

FIG. 4 shows a perspective view of the hood mounted on the filter tray.

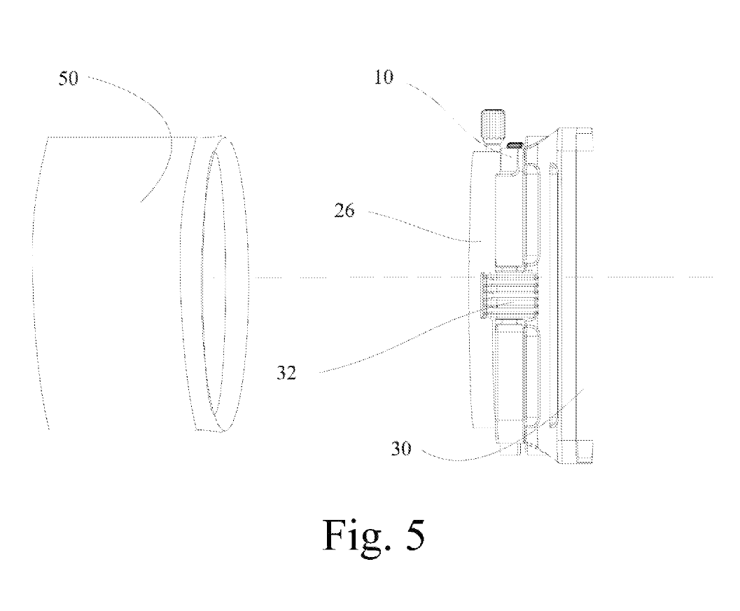

FIG. 5 shows a side view demonstrating the filter tray and matte box orientation relative to a camera lens and the optical path of the lens.

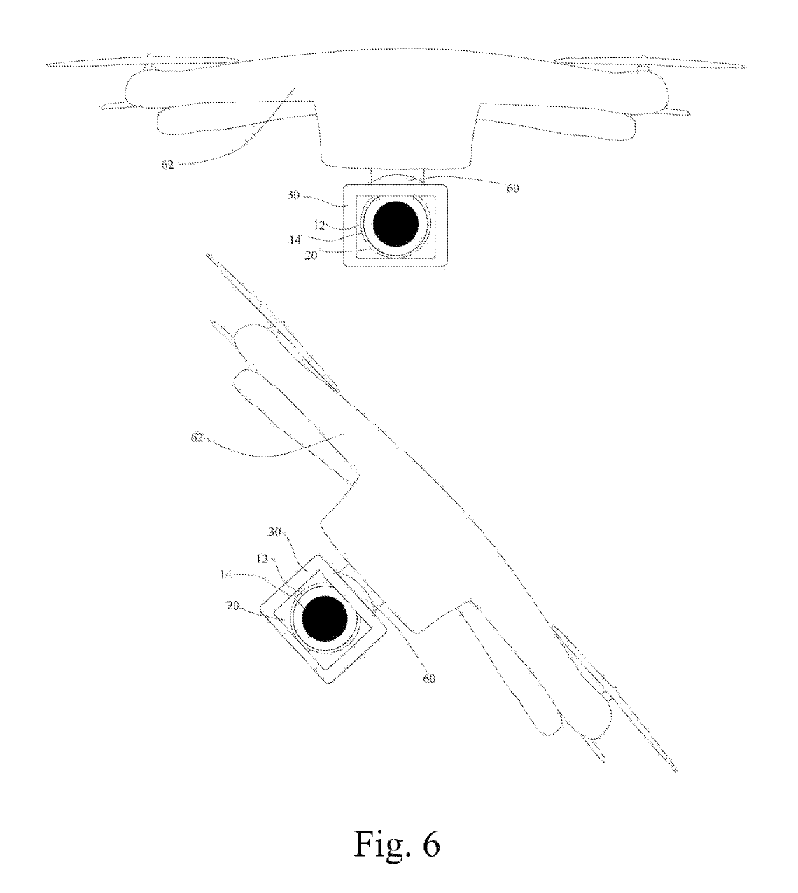

FIG. 6 depicts the matte box being rotated while attached to a drone camera.

### DETAILED DESCRIPTION OF THE DRAWINGS

FIG. 1 shows a bottom perspective view of the filter tray 10. Two tray magnets 16 are attached to the bottom side of the filter tray 10. In this embodiment the magnets 16 are embedded and lay flush with the surface of the filter tray 10. A glass optical element 15 is coupled with by a rotatable Frame 12 component of the filter tray 10.

FIG. 2 shows the coupling components of the filter tray 10 and filter slot 20. The filter tray 10 contains a frame 12 capable of receiving and operatively coupling image altering camera filters. An optical opening 14 is aligned with the camera's optical path. The image altering element of the filter is positioned in the optical opening 14 when the filter is coupled. Two tray magnets 16 are embedded in the bottom of the filter tray 10.

The filter slot 20 has a shelf 22 opening in the top corresponding to the dimensions of the filter tray 10. A lens clamp 26 extends from the slot 20. The lens clamp enables coupling with a camera and can be adjusted by twisting a lens clamp screw 24. In this embodiment the lens clamp screw 24 is cylindrical and extends vertically along the slot 20; a knurled knob at the top permits easier rotation. Two base magnets 28 are embedded in the bottom surface of the filter slot 20. The base magnets 28 are configured to align with tray magnets 16 when the tray is inserted into the shelf 22.

FIG. 3 depicts the filter tray 10 inserted and coupled. The dashed line represents the optical path relative to which the components are oriented. The filter tray 10 slides into the slot 20 until the magnetic force of the tray magnets 16 and base magnets 28 securely couple the two components. The optical opening 14 aligns with the scope 26, permitting a clear optical path for the camera lens.

A detached hood 30 is positioned in front of the slot 20. The hood has two hood snap-on tabs 32. The hood snap-on tabs 32 have male coupling components on the inside. Two modular accessory ports 25 are positioned on the outside of the hood slot 20. The modular accessory ports 25 are indentations and the corresponding female coupling element of the hood snap-on tabs 32.

FIG. 4 shows hood 30 attached to the filter slot 20. The hood snap-on tabs 32 couple with the modular accessory ports 25. The filter tray 10 is magnetically coupled.

FIG. 5 demonstrates the position of an exemplary camera lens 50 relative to the filter tray 10. The camera is coupled with the matte box. The optical path, represented by the dashed line, is perpendicular to the filter tray 10. The matte box may be coupled to the lens 50 by the lens clamp 26.

FIG. 6 shows a matte box attached to a drone camera 60. The figure demonstrates a drone 62 rolling around the horizontal axis while filming. Quick movements can cause an uncoupled filter tray 10 to move or dislodge. The tray magnets 16 and base magnets 28 securely couple the tray to keep it stable against force caused by quick movement.

The foregoing discussion discloses and describes merely exemplary methods and embodiments. As will be understood by those familiar with the art, the disclosed subject matter may be embodied in other specific forms without departing from the essence or characteristics thereof.

Accordingly, the foregoing disclosure is intended to be illustrative, but not limiting, of the scope of the invention, which is set forth in the claims.

We claim,:

1. A method of coupling a camera filter, comprising:
a. A filter tray comprising a frame, an optical opening, and at least one tray magnet,
b. Said frame capable of coupling the image altering element of a camera filter in the optical opening,
c. Said tray magnet being embedded or otherwise attached to the filter tray,
d. A tray slot configured to receive the filter tray,
e. Said filter tray of at least one magnet with the opposite polarity to the filter magnet(s),
f. Said magnets providing a means of coupling the filter tray and filter slot

2. A device for coupling a camera filter, comprising:
a. A filter tray capable of operatively coupling the image altering component of a camera filter,
b. A plurality of magnets embedded in the filter tray,
c. A filter slot configured to allow installment of the filter tray,
d. A plurality of magnets embedded in the filter slot configured to align with magnets in filter tray when said filter tray is inserted,
e. Said magnets having opposite polarities permitting attraction force as means of coupling.

3. A matte box for a camera, comprising:
a. A filter slot comprised of at least one base magnet,
b. A lens hood with means of coupling said filter slot,
c. A filter tray configured for installment in the filter slot,
d. Said filter tray comprised of at least one tray magnet configured to align with the base magnet when the filter tray is installed.
